(19) United States
(12) Patent Application Publication
(10) Pub. No.: US 2017/0372005 A1
(43) Pub. Date: Dec. 28, 2017

(54) SYSTEMS AND METHODS FOR PROCESSING SEQUENCE DATA FOR VARIANT DETECTION AND ANALYSIS

(71) Applicant: BOARD OF REGENTS OF THE UNIVERSITY OF TEXAS SYSTEM, Austin, TX (US)

(72) Inventor: Turner Conrad, San Antonio, TX (US)

(21) Appl. No.: 15/539,043

(22) PCT Filed: Dec. 28, 2015
(86) PCT No.: PCT/US15/00501

§ 371 Date: Jun. 22, 2017

Related U.S. Application Data
(60) Provisional application No. 62/095,104, filed on Dec. 22, 2014.

(51) Int. Cl. G06F 19/28; G06F 19/22; G06F 19/18

(52) U.S. Cl. CPC G06F 19/28; G06F 19/18; G06F 19/22

(57) ABSTRACT

Systems and methods for processing sequence data are disclosed herein. In an embodiment, the system is comprised of a computing device that is configured for receiving, storing, and processing sequence data utilizing object-oriented functions. Sequencing is disclosed herein which provides for the customization of sequencing and analysis processing for next generation sequence processing and analysis. The system may be characterized as a bioinformatics system, which uses object oriented functions to process and store sequencing data efficiently and without the need for extensive programming knowledge. Object instances configured as part of the system may be manipulated, transformed, probed, and shared in memory, yet still saved to the disk. Due to the nature of sequence representation within the system, the required disk space needed is much less than existing bioinformatics programs. In another embodiment, MATLAB is utilized as part of the configuration of the system. Due to its object-oriented approach it may be adapted to more complex development functions and processing. This provides for much needed flexibility and ease of use.

### CROSS-REFERENCE TO RELATED APPLICATIONS

This application claims priority to, and is the National Stage of International Application No. PCT/US15/00501 filed on Dec. 22, 2015 and claims priority of U.S. Provisional Patent Application Ser. No. 62/095,104, filed on Dec. 22, 2014, the contents of which are incorporated by reference in their entirety.

### STATEMENT REGARDING FEDERALLY SPONSORED RESEARCH OR DEVELOPMENT

This invention was made with government support under R01AI64537 awarded by the National Institute of Health (NIH)—CDC as well as W911NF-11-1-0136 awarded by the Army Research Office DoD. The government has certain rights in the invention.

### FIELD OF THE INVENTION

The present invention relates generally to systems and methods for processing and analyzing sequence data. More specifically, the present invention relates to systems and methods for lossless compression, variant detection and annotation, and sample comparison of reference-mapped next generation sequencing data.

### BACKGROUND OF THE INVENTION

Without limiting the scope of the disclosed device and method, the background is described in connection with systems and methods for lossless compression, variant detection and annotation, and sample comparison of reference-mapped next generation sequencing data.

Since the completion of the Human Genome Project, the sequencing industry has shifted its focus to multiple areas. One of those areas has been the usage of next-generation sequencing technology (NGS). NGS seeks to obtain higher throughput and/or lower cost nucleic acid sequencing technology. In general, NGS extends the process of capillary electrophoresis sequencing from small fragments of DNA to a much larger scale. This allows for the rapid sequencing of larger stretches of DNA base pairs spanning entire genomes. The resulting data produced by parallel NGS is often large, complex and difficult to interpret.

To aid researchers in the interpretation of NGS data, numerous bioinformatics programs and systems have been developed to map short sequence reads to a reference sequence that detect and functionally characterize variants. However, the current set of software and systems operate in a very procedural manner that results in tedious work. Each program or disparate system performs one operation and produces a specially formatted output file that is then used in the next step of the method or system. This approach becomes very tedious, as the process must be repeated until the desired results are obtained.

Most current bioinformatics systems and tools require extensive computer skills and are intractable to customization without these skills. That is because of their complexity in being configured with instructions written in complex compiled programming languages, the system is not easily modified for custom analysis. Existing systems and tools that are user-friendly are necessary for inexperienced users but, due to their simplicity, they are limited in their functionality. Thus, there exists a need for a system that is both highly customizable yet very user friendly.

In view of the foregoing, it is apparent that there exists a need in the art for a system directed to processing sequence data for variant detection and analysis, which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides for systems and methods directed to processing sequence data for variant detection and analysis.

In one embodiment, the system is comprised of a computing device that is configured for receiving, storing, and processing sequence data utilizing object-oriented functions. In another embodiment, the object-oriented functions are instructions written in non-compiled code. In yet another embodiment, the system is configured to process in a Matlab environment using at least one class in Matlab to overcome the limitations in the prior art by providing an object oriented approach to handling referenced-mapped next generations sequence (NGS) data. In an embodiment, object instances of at least one class can be manipulated, transformed, probed, and shared in memory, yet still saved to disk.

Moreover, because the objects/classes are mere representations of the original sequence read alignment, they require a fraction of disk space compared with the original compressed read alignment file—over 70 fold less in some cases—with the only loss of information being the decoupling of sequence read content from permutations. Because a combination of read content and permutation information is not strictly necessary for many NGS data operations, this compression can be characterized as lossless. While in an embodiment, the configuration of system utilizes instructions that are interpreted and not compiled, the processing capabilities match the speed advantages of compiled instructions due to the manner in which the information is stored.

The processing capabilities of disclosed systems and methods were applied to NGS bioinformatics analysis to detect, functionally characterize, and compare variants across samples utilizing only one class method configured in the system and was able to complete in tens of seconds. Not only does the systems and methods disclosed herein provide the researcher with enhanced customizability for NGS data analysis, but also greatly reduces the size of the data to be analyzed, thus reducing the information complexity for analysis.

In summary, the present invention discloses systems and methods for processing and analyzing sequence data. More specifically, the present invention relates to systems and methods for lossless compression, variant detection and annotation, and sample comparison of reference-mapped next generation sequencing data.

### BRIEF DESCRIPTION OF THE SEVERAL VIEWS OF THE DRAWINGS

The accompanying drawings, which are incorporated in and form a part of the specification, illustrate a preferred embodiment of the present invention, and together with the description, serve to explain the principles of the invention. It is to be expressly understood that the drawings are for the purpose of illustration and description only and are not intended as a definition of the limits of the invention. In the drawings:

FIG. 1 is a mapping of the system's solution balance in accordance with the teachings of the present disclosure;

FIG. 2 is the system's application to NGS data analysis in accordance with the teachings of the present disclosure;

FIG. 3 is a variant analysis procedure and system functionality mapping in accordance with the teachings of the present disclosure;

FIG. 4 is a genomic suite variant workflow and output flowchart in accordance with the teachings of the present disclosure;

FIG. 5 is an open-source variant workflow and output flowchart in accordance with the teachings of the present disclosure;

FIG. 6 is the system's variant workflow and output flowchart in accordance with the teachings of the present disclosure;

FIG. 7 is the system's object properties layout in accordance with the teachings of the present disclosure;

FIG. 8 is the system container information layout in accordance with the teachings of the present disclosure;

FIG. 9 is a container comparison in accordance with the teachings of the present disclosure.

### DETAILED DESCRIPTION OF THE INVENTION

Disclosed herein are systems and methods directed to processing sequence data for variant detection and analysis. The numerous innovative teachings of the present invention will be described with particular reference to several embodiments (by way of example, and not of limitation).

In embodiments, the invention is an object class configured to be used in sequence processing systems. In other embodiments, the system is comprised of a computing device that is configured for receiving, storing, and processing sequence data. The system being further configured in embodiments of the system with object-oriented functions for processing and analyzing sequence data. The computing device in an embodiment is comprised of a processor, memory, and disk space or storage. The disk space, or storage medium is used for long-term storage of programs, data, an operating system, and other persistent information. In some embodiments, the disk space may be higher latency than memory, but characteristically have higher capacity. In other embodiments, a single hardware device may serve as both memory and disk space. In embodiments, the computing device may also be comprised of hardware and software interfaces to other components of the system such as additional computing devices configured as interfaces or sources of files and/or data to be processed by the system.

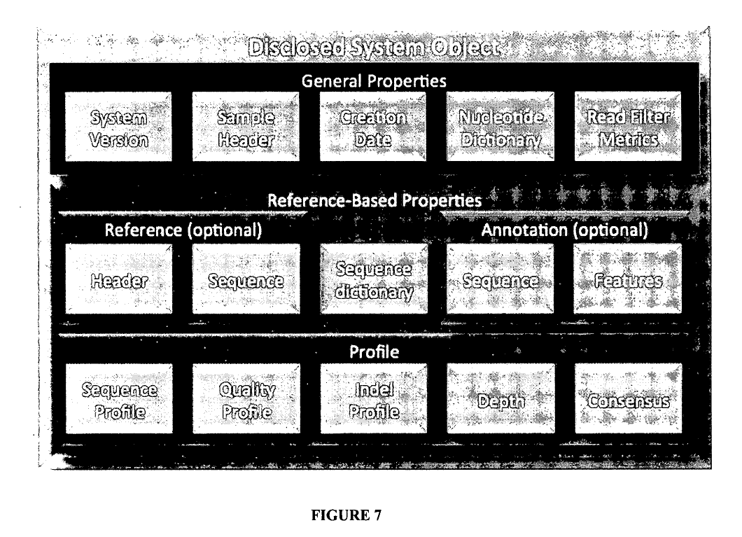

In an embodiment, the object-oriented functions are classes written in non-compiled code such as interpreted instructions. In other embodiments, the interpreted instructions non-compiled code is implemented in a Matlab environment. Embodiments of the system utilize system classes implemented as a self contained Matlab class. Like any other object-oriented programming language class, it contains a set of properties and methods specific to the class which will be discussed in more detail under FIG. 7.

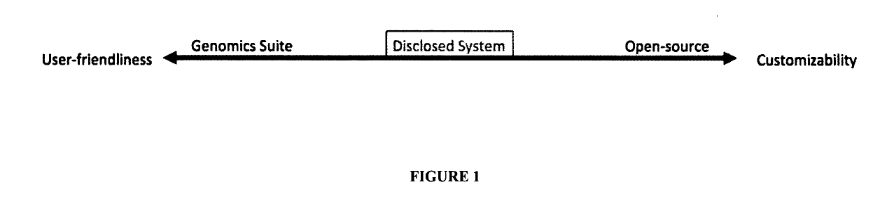

Reference is first made to FIG. 1, a mapping of the system's solution balance in accordance with the teachings of the present disclosure. The disclosed system and methods achieve a balance between ease of use and being customizable. With the implementation of object-oriented classes for processing, not only is the system easy to use for users, but method and GUI development are simplified by the system. The system may be tailored to inexperienced users with the integration of a presentation layer or graphical user interface (GUI) while still remaining available for experienced users to further develop without compiling. In an embodiment, Matlab is utilized to provide a configuration environment for processing in a programming language not compiled.

At its core the system class(es) is/are designed to improve upon and replace the way in which reference-mapped NGS sequence data is contained. Currently, the sequence/binary alignment map (SAM/BAM) file format is used to hold this NGS data as a list of sequence reads, associated quality scores, CIGAR alignments, and the location of where each read aligns to its reference. The sum of this information often requires a fast computer processor, ample memory size, and large amounts of disk space to store and process due to the sheer number of sequence reads that can be generated by NGS. Though the BAM format is the compressed version of the SAM format, these files may still require tens of megabytes to tens of gigabytes of storage space, with many above one gigabyte. The SAM/BAM format is a serialized representation of the full scale alignment of sequence reads to a reference sequence, but this set of information can be further compressed by transforming it into a sequence profile. A sequence profile is a two-dimensional numeric matrix that represents the number of molecular monomers (nucleotide/amino acid) that occurs at each position along a multiple sequence alignment, such as that represented in a SAM/BAM file. The caveat in alignment to sequence profile conversion is that quality score information and insertions that do not exist in the reference sequence cannot be maintained by the two-dimensional sequence profile.

By taking an object-oriented approach to this problem, the disclosed systems' and methods' class object(s) can contain all of this information at a fraction of the size of a BAM file. Only two parts of the information in the read alignment is lost: (1) the sequence permutation of each read and (2) the coupling of individual quality scores to individual nucleotides. However, for many types of downstream analysis, this information is unnecessary. Additionally, the manner in which read information is stored in a SAM/BAM file requires that it be reconstructed into an alignment by some means before it becomes tractable to interpretation. With the system's object(s), the alignment information can be easily accessed without reconstruction or further interpretation. At the same time, with the system being configured with a high-level interpreted programming language (rather than a compiled language) an advantage is achieved for novel method development. Combined with the ease in which the sequence data can be accessed, creating new methods is much less complicated than doing the same using other systems and software tools written in compiled languages

Most NGS data systems and software tools are procedural and sequential in nature, or they are completed step-by-step both within and between each tool. Those skilled in the art of bioinformatics develop and use individual tools to manipulate, convert, transform, or interpret data with unique file formats as intermediate information containers; this process is oftentimes referred to as a workflow or pipeline and is the means by which raw data is turned in human-interpretable output. While this system is beneficial for points where different programs can be used to process information from the same file format, the same stepwise analysis can be achieved by the disclosed systems by containing the sequencing as a class object variable specific for holding said sequencing data. In using this system, rather than develop and implement entirely novel methods, users can tailor the system without having to develop and compile complex programs or perform complex system configurations. In addition, the disclosed systems and methods allow for manipulation of objects in memory rather than having to save information to a file, though, multidimensional object instances can also be saved as serialized and compressed .mat files.

Most current bioinformatics software tools—typically freeware—require extensive computer skills and are intractable to customization without extensive software development skills and experience. More user-friendly tools—typically paid software—are necessary for inexperienced users, but are then limited in their functionality and also intractable to novel method development. The system's class relies on the principle of least astonishment (POLA) in both use and development to simplify NGS data analysis. At present, there is a widening gap between the ability to collect and analyze NGS data as only experienced individuals have the capability to process it.

By using an object-oriented approach of POLA applied to NGS data analysis, the researcher can focus on the analysis and method development, rather than learning how to use multiple software tools to their advantage. In addition, by reducing the size of NGS data, it becomes more transportable and manipulatable than current methods of data containment. Those who would be most interested in using the disclosed systems' class would fit into one of two categories of biological researchers: (1) those who are inexperienced and are willing to pay for software that is easy to use and (2) those who are semi- or fully-experienced bioinformaticians and/or genomicists who desire a method development environment where access to data is easy, simple, and compliant. Because the system's class is more of a framework for method development, usefulness to the end-user cannot be predicted beyond the variant detection and characterization method included in the system's configuration instructions. Though, compared to current practice for this procedure alone, the disclosed system offers considerable improvements over the typical workflow as a testament to the ease in which novel methods can be developed and implemented.

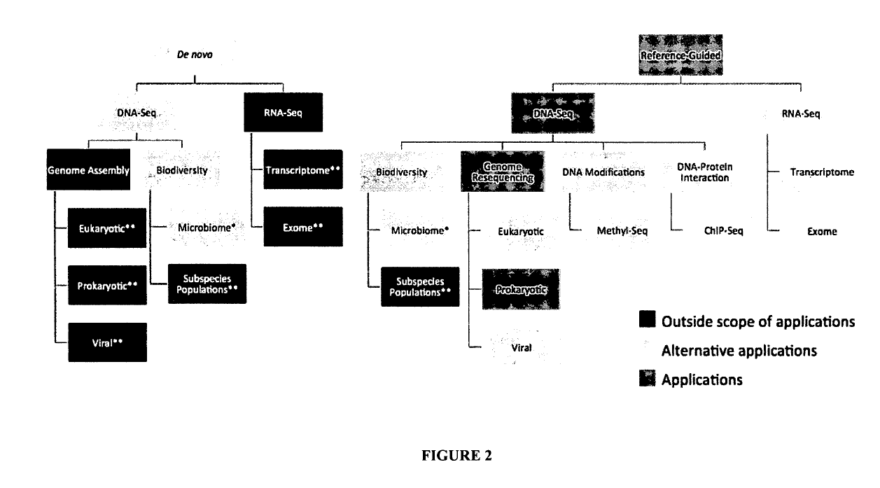

Reference is next made to FIG. 2, a mapping of the various system applications to next generation sequencing (NGS) data analysis in accordance with the teachings of the present disclosure. Those marked with one asterisk are where a read sequence is typically required but can be overcome by transposing system structures/objects for storage of unique sequences and reads where the entire target locus must be covered. An example of this would be the 16S V2 region. Those marked with two asterisks are where overlapping reads are required. Profile/matrix approaches are not efficient for determining overlap compared to text/suffix approaches.

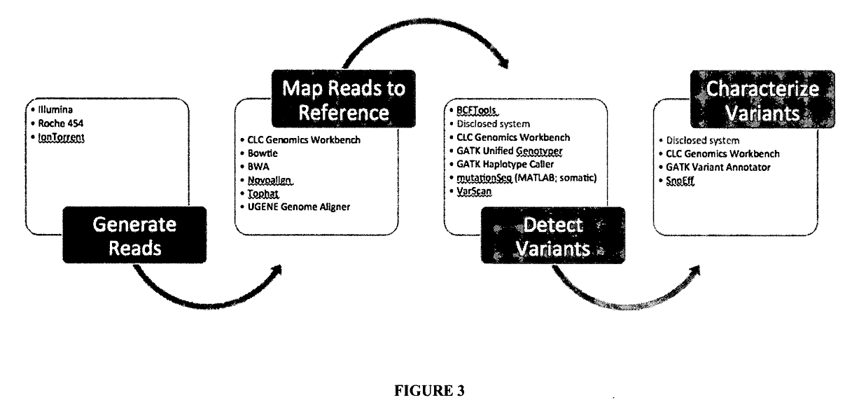

Reference is now made to FIG. 3, a variant analysis procedure and system functionality mapping in accordance with the teachings of the present disclosure. Variant detection and annotation is the primary motive for reference-guided DNA re-sequencing. That is, how does my sample differ from similar organisms? The disclosed system is able to provide the functionality and processing for achieving this answer. Illustrated here are the generalized bioinformatics steps necessary to generate and interpret variant data along with those tools in the prior art and the disclosed system.

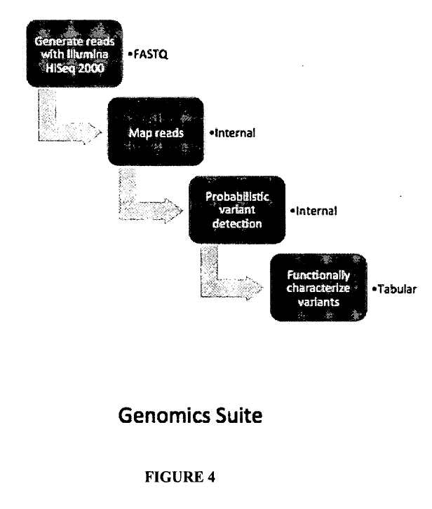

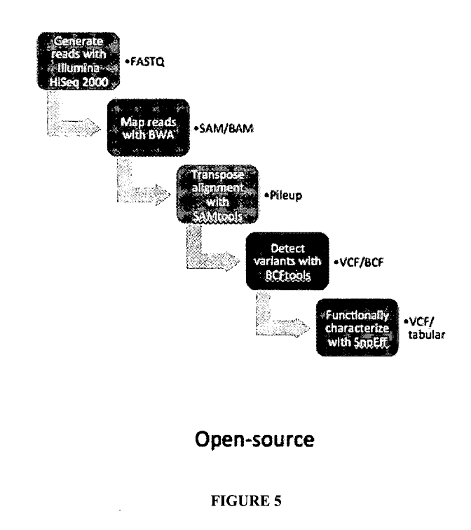

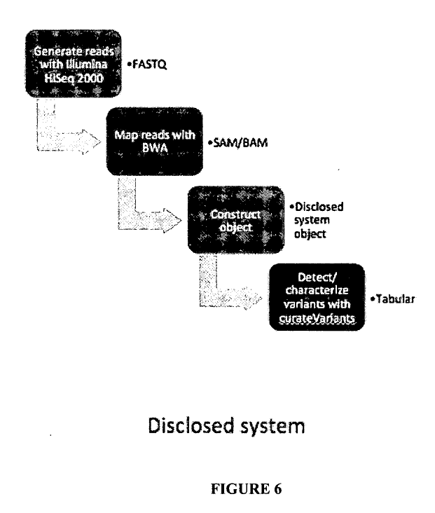

Reference is next made to FIG. 4 a genomic suite variant workflow and output flowchart in accordance with the teachings of the present disclosure and to FIG. 5, an open-source variant workflow and output flowchart in accordance with the teachings of the present disclosure and to FIG. 6, the system's variant workflow and output flowchart in accordance with the teachings of the present disclosure. In an embodiment, efficient read processing capabilities are configured in the disclosed system allowing only two instructions needed to generate an interpretable variant dataset from unaligned reads. Due to the system's configuration, the need for the pileup and VCF file formats are eliminated. In other embodiments, where the system is configured so that object instances may be saved to disk, recovered, and operated on in memory, the requirement for storing data in SAM and BAM formats are eliminated as well.

Reference is now made to FIG. 7, the system object properties layout in accordance with the teachings of the present disclosure. Illustrated here is an embodiment of a system object configuration in a high level layout comprising general properties and reference-based properties. The general properties may be comprised of one or more of the following: a system version, sample header, creation date, nucleotide dictionary, and read filter metrics. The reference based properties may be comprised of one or more of the following: reference header, reference sequence, sequence dictionary, annotation sequence, annotation features, sequence profile, quality profile, indel profile, depth, and consensus. In embodiments, general properties of the disclosed system's class include system version (“version”), sample name (“header”), object construction date (“date”), standard nucleotide set for sequence profile (“stdnt”), and read filtering statistics (“filters”). These properties are immutable and are maintained during the life of a system class object for reference. Another set of properties is centered on the reference sequences in which sequence reads were mapped. This set of sequences is referred to as a sequence dictionary (“dict”), and contains names of the references. The rest of the class properties have an entry corresponding to each dictionary entry: reference (“ref”), annotation (“annot”), and profile (“prof”). The reference property holds the reference sequence itself, while the annotation property holds the sequence and sequence feature annotations, such as genes. The profile property represents the information from a mapped reads file and is subdivided into the sequence profile (“seq”), sequence quality profile (“qual”), indel profile (“indel”), per-base read depths (“depth”), and consensus sequence (“consensus”). The sequence profile is a matrix of per-base nucleotide counts (called a profile) where each rows represent the standard nucleotide set and the number of columns corresponds to the length of the read alignment. Each nucleotide detected by NGS is assigned a Phred quality score that represents the probability that the base was called in error. Just as a single matrix entry of the sequence profile represents the sum of counts for that nucleotide at the given reference base position, the sequence quality profile is a sum of the qualities assigned to the nucleotides in the sequence profile and is directly paired to it. Since insertions and deletions (indels) cannot be represented by a sequence profile, a separate indel profile is characterized as a list of unique indels, their combined quality, and total counts in relation to read depth. Unlike the per-base sequence profile, the indel profile can consist of multi-nucleotide motifs because preserving this information context is necessary when functionally characterizing variants. The depth property is a vector of the number of reads that map to each reference base position and is the sum of counts in the sequence profile. The consensus sequence is the “average” base detected at each reference base position. Class properties are initially populated by the object constructor method. This method, called by the name of the class (BioProfile as an example and not a limitation) primarily takes a reference-mapped reads file, such as a sequence/binary alignment map (SAM/BAM)-formatted file, as input. Arguments for excluding information below a specified quality threshold, computational options such as parallel processor core and memory usage, and references/annotations can be passed to the object constructor and parsed by the class method “processArgs.” Following argument parsing, the constructor method loads the mapped reads file as a disclosed system class object, which is used to catalog and index the sequences in the file. The general object properties are then populated based on the version of the disclosed system class being used (“version”), name of the mapped reads file (“header”), and date (“date”). If a reference structure variable or FASTA filename or annotation structure variable or GenBank flatfile is passed as an argument to the class constructor, the class method “setReference” or “setAnnotation” are called to add the provided information into the “reference” or “annotation” property, respectively. Neither of these sets of information is required for object construction, but may be required for downstream analysis. The class method “filterReads” is then called to remove reads that do not meet quality and standards requirements and the reported statistics are placed in the “filters” property. The profile information is populated by splitting the BioMap object of reads into sets corresponding to each reference sequence and further spliced into bins of reads when called by the class method “processReads.” Within this step, the systems (BioProfile as an example and not a limitation) class method “compactAlignment” is used to align CIGAR-formatted sequence reads and quality strings through the built-in MATLAB executable (MEX) “bioinfoprivate.cigar2gappedsequencemex” and place each alignment into a master sequence or quality compact alignment. Nucleotides at each base position are counted for the sequence profile and the parallel quality scores summed for the sequence quality profile. In addition, “processReads” scans CIGAR strings for insertion and deletion indicators (“I” and “D”), extracts the indel sequence and quality from corresponding reads, and adds them to the indel profile, and counts the unique indels in the profile. Quality scores and the nucleotides they represent that do not meet default or user-defined thresholds are filtered out during the “processReads” method. Each bin of reads is processed in the above fashion and each set of sliced profiles is constructed into a full profile that is the final sequence, quality, and indel profile portions of the “prof” property. The depth portion is calculated by summing nucleotide counts at each reference base position and the systems (BioProfile as an example and not a limitation) class method “setConsensus” is called to calculate the consensus sequence from the sequence and indel profiles. If a reference or annotation is provided, or whenever their respective “set” methods are called, the systems (BioProfile as an example and not a limitation) class “trimProfile” method is used to cut the profiles down to the size of the reference sequences since reads can extend beyond the theoretical limit of the reference sequence if the reference is circularized. Following object construction, an object instance contains all of the information necessary for downstream analysis. To demonstrate the type of analysis that is required of NGS data, a method called “curateVariants” was developed to use the reference or annotation information contained within the object instance to detect single nucleotide variants (SNVs) that differ from the reference sequence and single or multiple nucleotide indels by their full occurrence (permutation-relevant) in the sequence and indel profiles, respectively, of the object instance. If an annotation was provided upon object construction or later added, the annotation information will be used to report the functional consequences of detected variants at the nucleotide, codon, and amino acid levels. Multiple object instances can be provided to class methods like “curateVariants,” so the method “versionCheck” is used to verify that the multiple system (BioProfile as an example and not a limitation) objects are compatible through a versioning scheme of major, minor, and revision system (BioProfile as an example and not a limitation) changes, with the former two indicating changes in compatibility. With multiple system (BioProfile as an example and not a limitation) objects, “curateVariants” will report the frequency of read depth that each detected variant encompasses in each sample if it is detected in any of the samples, as per the common bioinformatics procedure. The system (BioProfile as an example and not a limitation) class methods “setHeader,” “getIndels,” and “getSubset” were developed as examples of other system (BioProfile as an example and not a limitation) object manipulation and information retrieval operations. It should also be noted that indels are not recorded as nucleotide sequences in the indel profile, but rather as numeric representations of the original sequence with the standard nucleotide set as a key and the class methods “seq2code” and “code2seq” for converting between formats. This system offers considerable reduction in the indel profile size since all other indel profile information is numeric and storing string and numeric information together in a cell variable requires more space than a numeric matrix variable.

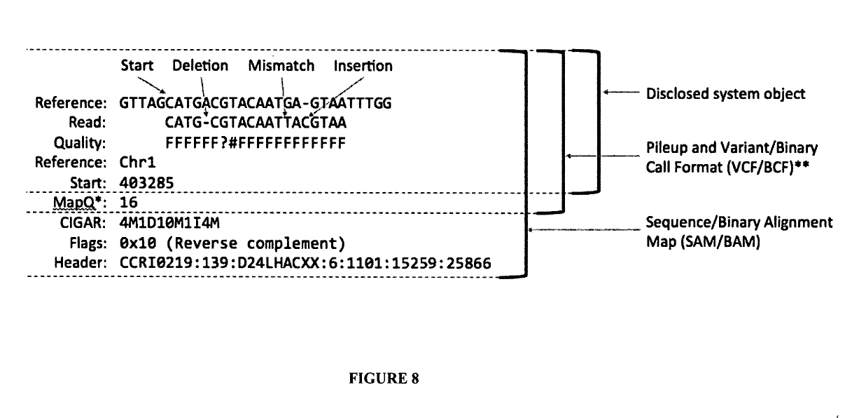

Reference is next made to FIG. 8, the system container information layout in accordance with the teachings of the present disclosure. The single asterisk applies to all bases in read sequence. In an embodiment, the avereage MapQ for each nucleotide count is removed from the system processing because the reference position-based profiling does not reflect original reads, so the data supplied by MapQ loses context. In an embodiment, the double asterisk refers to being able to record only variants or all sites (similarly to pileup and disclosed system), though typically only variants.

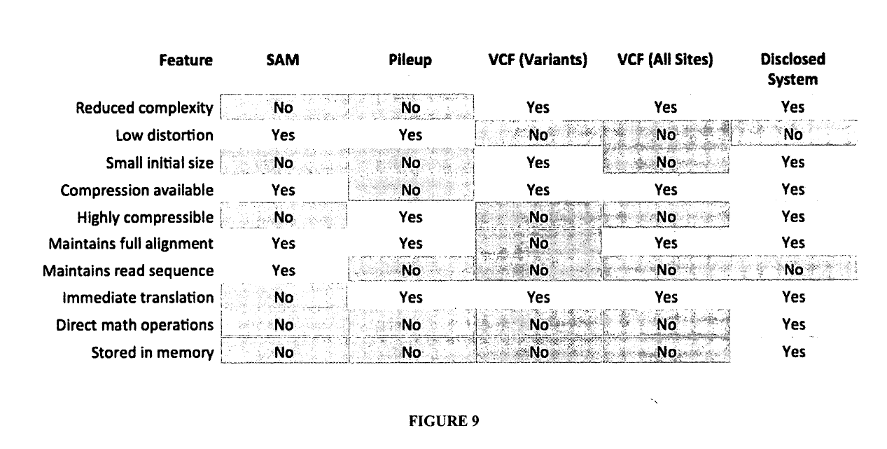

Lastly, reference is made to FIG. 9, a container comparison in accordance with the teachings of the present disclosure.

Appendix A reflects an embodiment of a configuration implemented.

The disclosed systems and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using the disclosed systems and methods for performing other sequence processing analysis and variant detection which can be achieved utilizing invention disclosed herein. Consequently, any embodiments comprising a one piece or multi piece system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods disclosed and claimed herein can be made and executed without undue experimentation in light of the present disclosure. While the device and methods of this invention have been described in terms of preferred embodiments, it will be apparent to those skilled in the art that variations may be applied to the systems and/or methods and in the steps or in the sequence of steps of the methods described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A system for processing sequence data for variant detection and analysis comprising:
a computing device configured to receive and/or store sequence data;
said computing device further configured to utilize a system object for processing and analyzing said sequence data.

2. The system of claim 1, wherein said computing device is configured to detect variants.

3. The system of claim 1, wherein said computing device is configured to characterize variants.

4. The system of claim 1, wherein said computing device is configured to detect and characterize variants.

5. The system of claim 1, wherein said system object is comprised of general properties and reference-based properties.

6. The system of claim 5, wherein said general properties are comprised of a system version, sample header, creation date, nucleotide dictionary, and read filter metrics.

7. The system of claim 5, wherein said reference-based properties are comprised of a sequence
dictionary, sequence profile, quality profile, indel profile, depth, and consensus.

8. The system of claim 7, wherein said referenced-based properties are further comprised of a reference header and reference sequence.

9. The system of claim 7, wherein said referenced-based properties are further comprised of an annotation sequence and annotation feature.

10. The system of claim 1, wherein said system is configured with object-oriented functions for receiving, storing, and processing sequence data.

11. The system of claim 10, wherein said object-oriented functions are instructions written in non-compiled code.

12. The system of claim 10, wherein said system is configured with Matlab and using at least one Matlab class.

13. The system of claim 10, wherein said Matlab classes can be manipulated, transformed, probed, and shared in memory, yet still saved to disk.

14. The system of claim 10, wherein said computing device is configured to detect variants.

15. The system of claim 10, wherein said computing device is configured to characterize variants.

16. The system of claim 10, wherein said computing device is configured to detect and characterize variants.

17. The system of claim 10, wherein said system object is comprised of general properties and reference-based properties.

18. The system of claim 17, wherein said general properties are comprised of a system version, sample header, creation date, nucleotide dictionary, and read filter metrics.

19. The system of claim 17, wherein said reference-based properties are comprised of a sequence dictionary, sequence profile, quality profile, indel profile, depth, and consensus.

20. The system of claim 17, wherein said referenced-based properties are further comprised of a reference header, reference sequence, annotation sequence, and annotation features.
